(19) United States
(12) Patent Application Publication
(10) Pub. No.: US 2006/0118712 A1
(43) Pub. Date: Jun. 8, 2006

(54) Nanostructure sample supports for mass spectrometry

(76) Inventors: Dan-Hui Yang, Sunnyvale, CA (US); Ying-Lan Chang, Cupertino, CA (US); Timothy Herbert Joyce, Mountain View, CA (US)

Correspondence Address: Agilent Technologies, Inc;Legal Department, DL429, Intellectual Property Administration, P.O. Box 7599, Loveland, CO, 80537-0599, US

(21) Appl. No.: 11/003,122

(22) Filed: Dec. 3, 2004

(51) Int. Cl. B01D 59/44; H01J 49/00

(52) U.S. Cl. 250/288; 250/284

(57) ABSTRACT

A sample support for ionizing a sample is described. The sample support comprises a reflective nanostructure material for reflecting incident light to ionize the sample on the sample support.

### TECHNICAL FIELD

The technical field of the invention relates to analytical instruments and, in particular, to mass spectrometry.

### BACKGROUND

A variety of analytical instruments can be used for analyzing analytes such as biomolecules. More recently, mass spectrometry has gained prominence because of its ability to handle a wide variety of analytes with high sensitivity and rapid throughput. A variety of ion sources have been developed for use in mass spectrometry. Many of these ion sources comprise some type of mechanism that produces ions in accordance with an ionization process. One particular type of ionization process that is used is Matrix Assisted Laser Desorption Ionization (“MALDI”). One benefit of MALDI is its ability to produce ions from a wide variety of biomolecules such as proteins, peptides, oligosaccharides, and oligonucleotides. Another benefit of MALDI is its ability to produce ions with reduced fragmentation, thus facilitating identification of analytes from which the ions are produced.

Typically, MALDI produces ions from a co-precipitate of an analyte and a matrix. The matrix can comprise organic molecules that exhibit a strong absorption of light at a particular wavelength or a particular range of wavelengths, such as in the ultraviolet range. Examples of the matrix comprise 2,5-dihydroxybenzoic acid, 3,5-dimethoxy-4-hydroxycinnarnic acid, α-cyano-4-hydroxycinnamic acid, and the like. For a conventional MALDI mass spectrometry system, an analyte and a matrix are dissolved in a solvent to form a solution, and the solution is then applied to or positioned on a sample support. As the solvent evaporates, the analyte and the matrix form a co-precipitate on the sample support. The co-precipitate is then irradiated with a short laser pulse, which induces an accumulation of energy in the co-precipitate through electronic excitation or molecular vibration of the matrix. As the matrix dissipates the energy by desorption, the matrix carries the analyte into a gaseous phase. During this desorption process, ions are produced from the analyte by charge transfer between the matrix and the analyte.

During operation of a conventional MALDI mass spectrometry system, absorption of light by a matrix or by an analyte can affect ionization efficiency for the analyte, which, in turn, can affect sensitivity of mass spectrometric analyses. Accordingly, it is desirable to enhance absorption of light by the matrix or by the analyte, such that mass spectrometric analyses have a desired level of sensitivity.

### SUMMARY

The invention provides a mass spectrometry system. The mass spectrometry system comprises an ion source comprising a light source and a sample support adjacent to the light source. The sample support comprises a reflective nanostructure material for ionizing a sample on the sample support. The mass spectrometry system also comprises a detector downstream from the ion source for detecting ions.

The invention also provides an ion source. The ion source comprises a light source for producing light. The ion source also comprises a sample support adjacent to the light source and comprising a reflective nanostructure material for reflecting the light from the light source to ionize a sample on the sample support.

The invention also provides a sample support for ionizing a sample. The sample support comprises a reflective nanostructure material for reflecting incident light to ionize the sample on the sample support.

The invention further provides a method of ionizing a sample. The method comprises providing a sample support comprising a reflective nanostructure material. The method also comprises reflecting light that is incident on the reflective nanostructure material towards the sample. The method further comprises ionizing the sample.

Advantageously, embodiments of the invention provide enhanced ionization efficiency, such that mass spectrometric analyses have a desired level of sensitivity. For some embodiments of the invention, enhanced ionization efficiency can be achieved by using certain materials that promote ionization of a sample by enhancing absorption of light by the sample.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a mass spectrometry system implemented in accordance with an embodiment of the invention.

FIG. 2 illustrates a sample support comprising a set of nanostructures, according to an embodiment of the invention.

FIG. 3 illustrates a sample support comprising a set of nanostructures, according to another embodiment of the invention.

### DETAILED DESCRIPTIONS

### Definitions

The following definitions apply to some of the elements described with respect to some embodiments of the invention. These definitions may likewise be expanded upon herein.

As used herein, the singular terms “a,” “an,” and “the” comprise plural referents unless the context clearly dictates otherwise. Thus, for example, reference to a sample support can comprise multiple sample supports unless the context clearly dictates otherwise.

As used herein, the term “set” refers to a collection of one or more elements. Thus, for example, a set of nanostructures can comprise a single nanostructure or multiple nanostructures. Elements of a set can also be referred to as members of the set. Elements of a set can be the same or different. In some instances, elements of a set can share one or more common characteristics.

As used herein, the term “adjacent” refers to being near or adjoining. Adjacent structures can be spaced apart from one another or can be in actual contact with one another. In some instances, adjacent structures can be coupled to one another or can be formed integrally with one another.

As used herein, the term “ionization efficiency” refers to a ratio of the number of ions produced in an ionization process and the number of electrons or photons used in the ionization process.

As used herein, the term “ultraviolet range” refers to a range of wavelengths from about 5 nanometer (“nm”) to about 400 nm.

As used herein, the term “infrared range” refers to a range of wavelengths from about 1 millimeter (“mm”) to about 750 nm.

As used herein, the term “nanometer range” or “nm range” refers to a range of sizes from about 0.1 nm to about 1,000 nm, such as from about 0.1 nm to about 500 nm, from about 0.1 nm to about 100 nm, from about 0.1 nm to about 50 nm, or from about 0.1 nm to about 10 nm.

As used herein, the term “micrometer range” or “nm range” refers to a range of sizes from about 0.1 micrometer (“μm”) to about 1,000 μm, such as from about 0.1 μm to about 500 μm, from about 0.1 μm to about 100 μm, from about 0.1 μm to about 50 μm, or from about 0.1 μm to about 10 μm.

As used herein, the term “aspect ratio” refers to a ratio of a largest dimension of a structure and an average of remaining dimensions of the structure, which remaining dimensions are orthogonal with respect to one another and with respect to the largest dimension. In some instances, remaining dimensions of a structure can be substantially the same, and an average of the remaining dimensions can substantially correspond to either of the remaining dimensions. Thus, for example, an aspect ratio of a cylinder refers to a ratio of a length of the cylinder and a cross-sectional diameter of the cylinder. As another example, an aspect ratio of a spheroid refers to a ratio of a major axis of the spheroid and a minor axis of the spheroid.

As used herein, the terms “reflective,” “reflecting,” and “reflection” refer to a bending or a deflection of light. A bending or a deflection of light can be substantially in a single direction, such as in the case of specular reflection, or can be in multiple directions, such as in the case of diffuse reflection or scattering. Reflective materials typically correspond to those materials that produce reflected light when those materials are irradiated with incident light. The reflected light and the incident light can comprise wavelengths that are the same or different.

As used herein, the terms “photoluminescent” and “photoluminescence” refer to an emission of light in response to energy excitation. Photoluminescent materials typically correspond to those materials that produce emitted light when those materials are irradiated with incident light. The emitted light and the incident light can comprise wavelengths that are the same or different.

As used herein, the terms “robust” and “robustness” refer to a mechanical hardness or strength. Robust materials typically correspond to those materials that exhibit little or no tendency to fragment under typical operating conditions, such as typical operating conditions of the sample supports described herein. One measure of robustness of a material is its Vicker microhardness expressed in kilogram/millimeter (“kg/mm”). Typically, the material is considered to be robust if its Vicker microhardness is greater than about 1,000 kg/mm.

As used herein, the terms “inert” and “inertness” refer to a lack of interaction. Inert materials typically correspond to those materials that exhibit little or no tendency to interact with a sample under typical operating conditions, such as typical operating conditions of the sample supports described herein. Typically, inert materials also exhibit little or no tendency to interact with ions produced from a sample in accordance with an ionization process. While a material is sometimes referred to herein as being inert, it is contemplated that the material can exhibit some detectable tendency to interact with a sample under certain conditions. One measure of inertness of a material is its chemical reactivity. Typically, the material is considered to be inert if it exhibits little or no chemical reactivity with respect to a sample.

As used herein, the terms “hydrophilic” and “hydrophilicity” refer to an affinity for water, while the terms “hydrophobic” and “hydrophobicity” refer to a lack of affinity for water. Hydrophobic materials typically correspond to those materials to which water has little or no tendency to adhere. As such, water on a surface of a hydrophobic material tends to bead up. Hydrophobic materials can sometimes be referred to as non-wetting materials. One measure of hydrophobicity of a material is a contact angle between a surface of the material and a line tangent to a drop of water at a point of contact with the surface. Typically, the material is considered to be hydrophobic if the contact angle is greater than about 90°.

As used herein, the term “nanostructure” refers to a structure that comprises at least one dimension in the nm range. A nanostructure can comprise any of a wide variety of shapes and can be formed from any of a wide variety of materials. Examples of nanostructures comprise nanowires, nanotubes, nanoparticles, and the like.

As used herein, the term “nanowire” refers to an elongated nanostructure. Typically, a nanowire is substantially solid and, thus, can exhibit characteristics that differ from those of certain elongated, hollow nanostructures. In some instances, a nanowire can be represented as comprising a filled cylindrical shape. Typically, a nanowire comprises a cross-sectional diameter in the nm range, a length in the μm range, and an aspect ratio that is about 2 or greater. Examples of nanowires comprise those formed from semiconductor materials, such as silicon, gallium nitride, zinc oxide, and the like. A nanowire typically comprises a substantially ordered array or arrangement of atoms and, thus, can be referred to as being substantially ordered. It is contemplated that a nanowire can comprise a range of defects and can be doped or surface functionalized. It is also contemplated that a nanowire can comprise a set of heterojunctions or can comprise a core/sheath configuration. For example, a nanowire can comprise a core formed from zinc oxide and a sheath surrounding the core and formed from gallium nitride. Nanowires can be formed using any of a wide variety of techniques, such as arc-discharge, laser ablation, chemical vapor deposition, and the like.

As used herein, the term “nanotube” refers to an elongated, hollow nanostructure. In some instances, a nanotube can be represented as comprising an unfilled cylindrical shape. Typically, a nanotube comprises a cross-sectional diameter in the nm range, a length in the μm range, and an aspect ratio that is about 2 or greater. Examples of nanotubes comprise those formed from semiconductor materials, such as carbon, silicon, gallium nitride, and the like. A carbon nanotube can be formed as a Single-Walled Carbon Nanotube (“SWCNT”) or a Multi-Walled Carbon Nanotube (“MWCNT”). A SWCNT can be represented as a single graphite layer that is rolled into a cylindrical shape. A SWCNT typically comprises a cross-sectional diameter that is less than about 5 nm, such as from about 0.1 nm to about 5 nm. A MWCNT can be represented as multiple graphite layers that are rolled into concentric cylindrical shapes. A MWCNT typically comprises a cross-sectional diameter that is about 3 nm or greater, such as from about 3 nm to about 100 nm. A nanotube typically comprises a substantially ordered array or arrangement of atoms and, thus, can be referred to as being substantially ordered. It is contemplated that a nanotube can comprise a range of defects and can be doped or surface functionalized. Nanotubes can be formed using any of a wide variety of techniques, such as arc-discharge, laser ablation, chemical vapor deposition, and the like. Nanotubes can also be formed from nanowires. For example, a nanowire can comprise a core/sheath configuration, and a core of the nanowire can be at least partly removed using any of a wide variety of techniques, such as preferential etching with xenon fluoride.

As used herein, the term “nanoparticle” refers to a spheroidal nanostructure. Typically, a nanoparticle comprises dimensions in the nm range and an aspect ratio that is less than about 2. Thus, for example, a nanoparticle can comprise a major axis and a minor axis that are both in the nm range. Examples of nanoparticles comprise those formed from semiconductor materials, such as carbon, zinc selenide, zinc sulfide, and the like. A nanoparticle typically comprises a substantially ordered array or arrangement of atoms and, thus, can be referred to as being substantially ordered. It is contemplated that a nanoparticle can comprise a range of defects and can be doped or surface functionalized. It is also contemplated that a nanoparticle can comprise a set of heterojunctions or can comprise a core/sheath configuration. For example, a nanoparticle can comprise a core formed from zinc selenide and a sheath surrounding the core and formed from zinc sulfide. Nanoparticles can be formed using any of a wide variety of techniques, such as aqueous synthetic routes and the like.

As used herein, the term “nanostructure material” refers to a material that comprises or is formed from a set of nanostructures. One example of a nanostructure material is one that comprises or is formed from a set of nanowires, namely a nanowire material. Another example of a nanostructure material is one that comprises or is formed from a set of nanotubes, namely a nanotube material. A further example of a nanostructure material is one that comprises or is formed from a set of nanoparticles, namely a nanoparticle material. In some instances, a nanostructure material can comprise a substantially ordered array or arrangement of nanostructures and, thus, can be referred to as being substantially ordered. For example, a nanostructure material can comprise an array of nanostructures that are substantially aligned with respect to one another or with respect to a certain axis, direction, plane, surface, or three-dimensional shape. As another example, a nanostructure material can comprise an array of nanostructures that are substantially regularly spaced with respect to one another or with respect to a certain lattice, such as any of a wide variety of two-dimensional lattices and three-dimensional lattices.

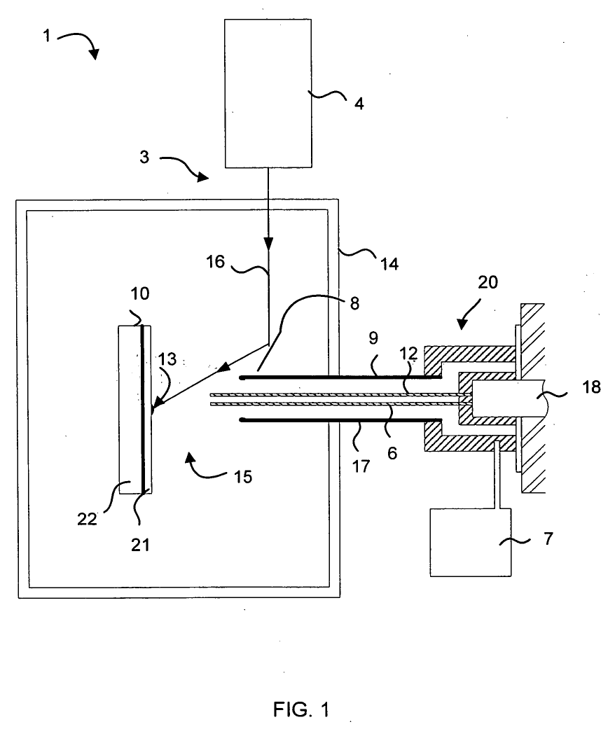

Attention first turns to FIG. 1, which illustrates a mass spectrometry system 1 implemented in accordance with an embodiment of the invention. The mass spectrometry system 1 comprises an ion source 3, which operates to produce ions. In the illustrated embodiment, the ion source 3 produces ions using MALDI. However, it is contemplated that the ion source 3 can be implemented to produce ions using any other ionization process, such as Atmospheric Pressure-Matrix Assisted Laser Desorption Ionization (“AP-MALDI”), Atmospheric Pressure Photo Ionization (“APPI”), and the like. It is also contemplated that the ion source 3 can be implemented as a multi-mode ion source that produces ions using a combination of ionization processes. As illustrated in FIG. 1, the mass spectrometry system 1 also comprises a detector system 20, which is positioned downstream with respect to the ion source 3 to receive ions. The detector system 20 operates to detect ions as a function of mass and charge.

As illustrated in FIG. 1, the ion source 3 comprises a light source 4, which operates to produce incident light 16. In the illustrated embodiment, the light source 4 is implemented as a laser that produces the incident light 16 in the form of a laser beam. Typically, the laser beam is pulsed and comprises a wavelength or a range of wavelengths in the ultraviolet range. However, it is contemplated that the laser beam need not be pulsed and can comprise any other wavelength or range of wavelengths, such as in the infrared range. In the illustrated embodiment, the ion source 3 also comprises a housing 14 that defines an ionization region 15 within which ions are produced. For certain implementations, the ionization region 15 can be maintained at a low pressure, such as under high vacuum conditions. As illustrated in FIG. 1, the ion source 3 further comprises a sample support 10, which is positioned within the ionization region 15 and is optically coupled to the light source 4 via a reflector 8. The sample support 10 operates to support or hold a sample 13, which comprises an analyte to be analyzed by the mass spectrometry system 1. For example, the sample 13 can comprise a co-precipitate of the analyte and a matrix, and the matrix can exhibit a strong absorption of the incident light 16. During operation, the light source 4 produces the incident light 16, which is directed into the ionization region 15 and reaches the sample support 10 via the reflector 8. The incident light 16 interacts with the sample 13 to produce ions from the analyte. The ions are released into the ionization region 15 and eventually reach the detector system 20.

Referring to FIG. 1, the detector system 20 comprises a mass analyzer 17, which operates to separate or select ions by mass-to-charge ratio. In the illustrated embodiment, the mass analyzer 17 is implemented as a time-of-flight analyzer. However, it is contemplated that other types of mass analyzers can be used, such as ion trap devices, quadrupole mass spectrometers, magnetic sector spectrometers, and the like. As illustrated in FIG. 1, the mass analyzer 17 comprises a capillary 6, which defines an internal passageway 12. During operation, ions are produced by the ion source 3, and the ions pass through the capillary 6 via the internal passageway 12. As illustrated in FIG. 1, the mass analyzer 17 also comprises a gas source 7 and a gas conduit 9 that encloses the capillary 6. The gas conduit 9 is fluidly coupled to the gas source 7 and operates to supply an inert gas to the ionization region 15. Referring to FIG. 1, the detector system 20 also comprises a detector 18, which is positioned with respect to the mass analyzer 17 to receive ions. During operation, ions pass through the capillary 6 and eventually reach the detector 18, which operates to detect the abundance of the ions and to produce a mass spectrum.

During operation of the mass spectrometry system 1, absorption of light by the sample 13 can affect ionization efficiency for the analyte, which, in turn, can affect sensitivity of mass spectrometric analyses. Accordingly, it is desirable to enhance absorption of light by the sample 13, such that mass spectrometric analyses have a desired level of sensitivity.

As illustrated in FIG. 1, the sample support 10 comprises a substrate 22 and a nanostructure material 21. In the illustrated embodiment, the nanostructure material 21 is formed as a layer that is adjacent to the substrate 22. It is also contemplated that the sample support 10 can be substantially formed of the nanostructure material 21. Advantageously, the nanostructure material 21 is reflective and can enhance absorption of light by the sample 13 by reflecting the incident light 16 back towards the sample 13. During operation, a portion of the incident light 16 that is not initially absorbed by the sample 13 passes through the sample 13 and eventually reaches the nanostructure material 21. In turn, the nanostructure material 21 can reflect this portion of the incident light 16 back towards the sample 13. In such manner, the nanostructure material 21 can provide multi-path irradiation of the sample 13 to enhance a capture cross-section of the incident light 16, thus promoting production of ions from the analyte. Alternatively, or in conjunction, the nanostructure material 21 can enhance absorption of light by the sample 13 by exhibiting photoluminescence in response to the incident light 16. During operation, a portion of the incident light 16 that is not initially absorbed by the sample 13 passes through the sample 13 and eventually reaches the nanostructure material 21. In turn, the nanostructure material 21 can produce emitted light in response to this portion of the incident light 16. In such manner, the nanostructure material 21 can irradiate the sample 13 with the emitted light, thus promoting production of ions from the analyte. Typically, the emitted light comprises a wavelength or a range of wavelengths in the ultraviolet range. However, it is contemplated that the emitted light can comprise any other wavelength or range of wavelengths.

In conjunction with enhancing absorption of light by the sample 13, the nanostructure material 21 can exhibit a number of other characteristics that are desirable for mass spectrometry. For example, another benefit of the nanostructure material 21 is that it can be highly robust when implemented in the sample support 10. Thus, the nanostructure material 21 can exhibit little or no tendency to degrade under typical operating conditions of the sample support 10, thus reducing undesirable chemical background noise in a mass spectrum. Robustness of the nanostructure material 21 can also allow the sample support 10 to be readily cleaned and to be reused for multiple tests. Another benefit of the nanostructure material 21 is that it can be highly inert with respect to typical analytes for mass spectrometry. Accordingly, use of the nanostructure material 21 can reduce undesirable interaction with an analyte for a current test as well as reduce contamination of the sample support 10 with a residual analyte from a previous test. A further benefit of the nanostructure material 21 is that it can be highly hydrophobic. Hydrophobicity of the nanostructure material 21 can serve to restrain the sample 13 (in its liquid form) from spreading along the sample support 10. In such manner, the nanostructure material 21 can serve to concentrate the sample 13 on the sample support 10, thus enhancing absorption of light by the sample 13. It is also contemplated that the nanostructure material 21 can be initially hydrophilic, and hydrophobicity of the nanostructure material 21 can be achieved by, for example, surface functionalization.

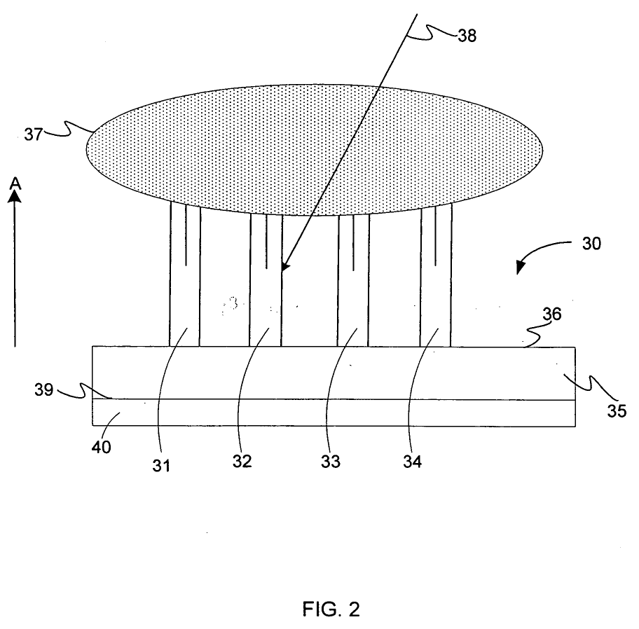

Attention next turns to FIG. 2, which illustrates a sample support 30 implemented in accordance with an embodiment of the invention. In the illustrated embodiment, the sample support 30 comprises a substrate 35 that comprises surfaces 36 and 39. The sample support 30 also comprises a set of nanostructures, namely nanostructures 31, 32, 33, and 34, which are adjacent to the surface 36 and operate to support a sample 37. The nanostructures 31, 32, 33, and 34 can comprise a set of nanowires, a set of nanotubes, or a combination thereof. While four nanostructures 31, 32, 33, and 34 are illustrated in FIG. 2, it is contemplated that more or less nanostructures can be used for other implementations. In the illustrated embodiment, the sample support 30 further comprises a reflective coating 40, which is adjacent to the surface 39. The reflective coating 40 can comprise a reflective material, such as aluminum.

As illustrated in FIG. 2, the nanostructures 31, 32, 33, and 34 are formed as an array that is substantially ordered. In particular, the nanostructures 31, 32, 33, and 34 are substantially aligned with respect to a common direction (illustrated as arrow A) and are substantially regularly spaced with respect to one another along the surface 36. In the illustrated embodiment, the common direction is substantially orthogonal with respect to the surface 36. In other words, an angle defined by the common direction and the surface 36 is substantially 90°. However, it is contemplated that this angle can be adjusted to differ from 90°, such as any other angle from 0°to 180°. As incident light 38 is directed towards the sample 37, the nanostructures 31, 32, 33, and 34 can enhance absorption of light by the sample 37 by reflecting the incident light 38 back towards the sample 37. In the illustrated embodiment, the reflective coating 40 can also enhance absorption of light by the sample 37 by reflecting the incident light 38 back towards the sample 37. Alternatively, or in conjunction, the nanostructures 31, 32, 33, and 34 can enhance absorption of light by the sample 37 by exhibiting photoluminescence in response to the incident light 38. Without wishing to be bound by a particular theory, it is believed that the substantially ordered configuration of the nanostructures 31, 32, 33, and 34 contributes to at least some of the desirable characteristics discussed above. It is contemplated that the alignment, spacing, and dimensions of the nanostructures 31, 32, 33, and 34 can be adjusted to tune these desirable characteristics to a particular level. For example, the alignment and spacing of the nanostructures 31, 32, 33, and 34 can be adjusted to enhance reflection of the incident light 38 that comprises a wavelength or a range of wavelengths in the ultraviolet range.

The sample support 30 can be formed using any of a wide variety of techniques. In particular, the nanostructures 31, 32, 33, and 34 can be grown on the substrate 35 using, for example, Metal-Organic Chemical Vapor Deposition (“MOCVD”). Alternatively, or in conjunction, the nanostructures 31, 32, 33, and 34 can be formed using any of a wide variety of techniques and then be deposited on the substrate 35. The alignment of the nanostructures 31, 32, 33, and 34 can depend on lattice matching between the nanostructures 31, 32, 33, and 34 and the substrate 35, cross-sectional diameters of the nanostructures 31, 32, 33, and 34, solid-liquid interfacial energies during growth or deposition, or a combination thereof. In some instances, the alignment of the nanostructures 31, 32, 33, and 34 can be achieved by applying an electric field during growth or deposition. The spacing of the nanostructures 31, 32, 33, and 34 can depend on positioning of catalysts used for MOCVD. In some instances, the positioning of the catalysts can be adjusted using, for example, polymer carrier techniques, electron-beam lithography, photolithography, imprint lithography, masks, and the like. The reflective coating 40 can be applied to the substrate 35 using any of a wide variety of techniques, such as spraying, dipping, painting, and the like.

For example, the substrate 35 can comprise a-sapphire, and the nanostructures 31, 32, 33, and 34 can comprise gallium nitride nanowires that are grown or deposited on the substrate 35. As another example, the substrate 35 can comprise α-sapphire, and the nanostructures 31, 32, 33, and 34 can comprise gallium nitride nanotubes that are grown or deposited on the substrate 35. As another example, the substrate 35 can comprise α-sapphire, and the nanostructures 31, 32, 33, and 34 can comprise zinc oxide nanowires that are grown or deposited on the substrate 35. As another example, the substrate 35 can comprise silicon that comprises a (111) crystal lattice, and the nanostructures 31, 32, 33, and 34 can comprise silicon nanowires that comprise cross-sectional diameters greater than about 20 nm and that are grown or deposited on the substrate 35. As another example, the substrate 35 can comprise silicon that comprises a (110) crystal lattice, and the nanostructures 31, 32, 33, and 34 can comprise silicon nanowires that comprise cross-sectional diameters less than about 5 nm and that are grown or deposited on the substrate 35. As another example, the substrate 35 can comprise silicon, and the nanostructures 31, 32, 33, and 34 can comprise silicon nanotubes that are grown or deposited on the substrate 35. As a further example, the substrate 35 can comprise silicon dioxide, silicon, or quartz, and the nanostructures 31, 32, 33, and 34 can comprise carbon nanotubes that are grown or deposited on the substrate 35.

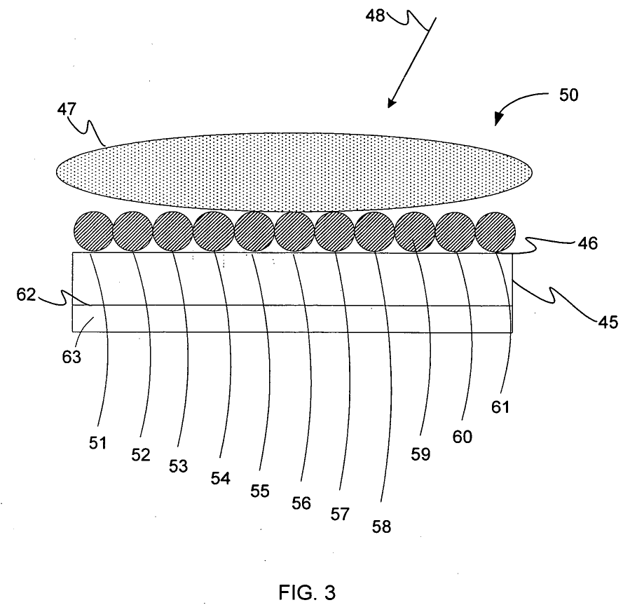

Attention next turns to FIG. 3, which illustrates a sample support 50 implemented in accordance with another embodiment of the invention. In the illustrated embodiment, the sample support 50 comprises a substrate 45 that comprises surfaces 46 and 62. The sample support 50 also comprises a set of nanostructures, namely nanoparticles 51, 52, 53, 54, 55, 56, 57, 58, 59, 60, and 61, which are adjacent to the surface 46 and operate to support a sample 47. While eleven nanoparticles 51-61 are illustrated in FIG. 3, it is contemplated that more or less nanoparticles can be used for other implementations. In the illustrated embodiment, the sample support 50 further comprises a reflective coating 63, which is adjacent to the surface 62. The reflective coating 63 can comprise a reflective material, such as aluminum.

As illustrated in FIG. 3, the nanoparticles 51-61 are formed as an array that is substantially ordered. In particular, the nanoparticles 51-61 are substantially regularly spaced with respect to one another along the surface 46. As incident light 48 is directed towards the sample 47, the nanoparticles 51-61 can enhance absorption of light by the sample 47 by reflecting the incident light 48 back towards the sample 47. In the illustrated embodiment, the reflective coating 63 can also enhance absorption of light by the sample 47 by reflecting the incident light 48 back towards the sample 47. Alternatively, or in conjunction, the nanoparticles 51-61 can enhance absorption of light by the sample 47 by exhibiting photoluminescence in response to the incident light 48. Without wishing to be bound by a particular theory, it is believed that the substantially ordered configuration of the nanoparticles 51-61 contributes to at least some of the desirable characteristics discussed above. It is contemplated that the spacing and dimensions of the nanoparticles 51-61 can be adjusted to tune these desirable characteristics to a particular level. For example, the spacing and dimensions of the nanoparticles 51-61 can be adjusted to enhance reflection of the incident light 48 that comprises a wavelength or a range of wavelengths in the ultraviolet range.

The sample support 50 can be formed using any of a wide variety of techniques. In particular, the nanoparticles 51-61 can be grown on the substrate 45 using, for example, MOCVD. Alternatively, or in conjunction, the nanoparticles 51-61 can be formed using any of a wide variety of techniques and then be deposited on the substrate 45. As discussed previously, the spacing of the nanoparticles 51-61 can depend on positioning of catalysts used for MOCVD. The positioning of the catalysts can be adjusted using, for example, polymer carrier techniques, electron-beam lithography, optical lithography, masks, and the like. The reflective coating 63 can be applied to the substrate 45 using any of a wide variety of techniques, such as spraying, dipping, painting, and the like.

For example, the nanoparticles 51-61 can comprise zinc selenide nanoparticles that are grown or deposited on the substrate 45. As another example, the nanoparticles 51-61 can comprise zinc sulfide nanoparticles that are grown or deposited on the substrate 45. As a further example, the substrate 45 can comprise silicon dioxide, silicon, or quartz, and the nanoparticles 51-61 can comprise carbon nanoparticles that are grown or deposited on the substrate 45.

A practitioner of ordinary skill in the art requires no additional explanation in developing the sample supports described herein but may nevertheless find some helpful guidance by examining the following references: Wu et al., “Controlled Growth and Structures of Molecular-Scale Silicon Nanowires,” NanoLetters, 4, 433-436, 2004; Kuykendall et al., “Crystallographic Alignment of High-Density Gallium Nitride Nanowire Arrays,” Nature Materials, 3, 524-528, 2004; and Kim et al., “Quantum Confinement Effects on Carriers in Self-Assembled ZnSe/ZnS Quantum Dots in a Lens Shape,” Phys. Stat. Sol. (c), 1, 775-778, 2004; the disclosures of which are incorporated herein by reference in their entireties.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process operation or operations, to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

We claim:

1. A mass spectrometry system, comprising:
(a) an ion source comprising:
(i) a light source; and
(ii) a sample support adjacent to the light source, the sample support comprising a reflective nanostructure material for ionizing a sample on the sample support; and
(b) a detector downstream from the ion source for detecting ions.

2. The mass spectrometry system of claim 1, wherein the light source comprises a laser.

3. The mass spectrometry system of claim 1, wherein the reflective nanostructure material is photoluminescent.

4. The mass spectrometry system of claim 1, wherein the reflective nanostructure material comprises a nanowire.

5. The mass spectrometry system of claim 1, wherein the reflective nanostructure material comprises a nanotube.

6. The mass spectrometry system of claim 1, wherein the reflective nanostructure material comprises a nanoparticle.

7. An ion source, comprising:
(a) a light source for producing light; and
(b) a sample support adjacent to the light source and comprising a reflective nanostructure material for reflecting the light from the light source to ionize a sample on the sample support.

8. The ion source of claim 7, wherein the light source comprises a laser.

9. The ion source of claim 7, wherein the reflective nanostructure material is photoluminescent.

10. The ion source of claim 7, wherein the reflective nanostructure material comprises a nanowire.

11. The ion source of claim 7, wherein the reflective nanostructure material comprises a nanotube.

12. The ion source of claim 7, wherein the reflective nanostructure material comprises a nanoparticle.

13. A sample support for ionizing a sample, comprising:
a reflective nanostructure material for reflecting incident light to ionize the sample on the sample support.

14. The sample support of claim 13, wherein the reflective nanostructure material is configured to produce emitted light in response to the incident light.

15. The sample support of claim 14, wherein at least one of the incident light and the emitted light comprises a wavelength in the ultraviolet range.

16. The sample support of claim 13, wherein the reflective nanostructure material comprises an array of nanostructures.

17. The sample support of claim 16, wherein the array of nanostructures is substantially ordered.

18. A method of ionizing a sample, comprising:
(a) providing a sample support comprising a reflective nanostructure material;
(b) reflecting light that is incident on the reflective nanostructure material towards the sample; and
(c) ionizing the sample.

19. The method of claim 18, wherein the reflective nanostructure material comprises a nanowire.

20. The method of claim 18, wherein the reflective nanostructure material comprises a nanotube.

21. The method of claim 18, wherein the reflective nanostructure material comprises a nanoparticle.
